(19) United States
(12) Patent Application Publication
(10) Pub. No.: US 2008/0314699 A1
(43) Pub. Date: Dec. 25, 2008

(54) Pad Retention Device

(75) Inventor: Mark Scott, Cheshire (GB)

Correspondence Address: SALTER & MICHAELSON;THE HERITAGE BUILDING, 321 SOUTH MAIN STREET, PROVIDENCE, RI, 029037128, US

(73) Assignee: BENTLEY MOTORS LIMITED, Cheshire (UK)

(21) Appl. No.: 12/090,544

(22) PCT Filed: Oct. 6, 2006
(86) PCT No.: PCT/GB2006/003716

§ 371 Date: Sep. 8, 2008

(30) Foreign Application Priority Data
Oct. 20, 2005 (GB) 0521326.9

(51) Int. Cl. F16D 65/04

(52) U.S. Cl. 188/73.39

(57) ABSTRACT

A pad retention device for a brake calliper for a disc brake for a vehicle comprises four spaced elongate cylindrical abutment pins (11) to (14) dispersed at spaced intervals around the periphery of the pad (10). The pins comprise two leading edge pins (11) and (12) and two trailing edge pins (13) and (14). Pin (13) is disposed adjacent the upper leading edge and a further pin (15) provides a centre locating and retaining pin which extends through an aperture (16) in the back plate of the pad. A cantilever spring (17) is mounted on pin (15) and pin (13). In use the spring (17) bears down on the pad (10), using pin (13) as a reaction point and centre locating and retaining pin (15) as a pivot, on the trailing edge side of the pin (15). This in turn tends to rotate the pad in an anticlockwise direction reducing or eliminating pad to abutment pin air gaps and therefore pad rattle and pad knock. This arrangement also provides improved squeal noise resistance.

The present invention relates to a pad retention device for a brake calliper for a disc brake for a vehicle.

In known brake callipers, a pad is attached to a back plate and maintained in position by cylindrical abutment pins which extend at right angles to both pad and back plate.

Brake callipers with cylindrical abutment pins suffer from two forms of noise, pad knock and pad rattle, that are related to the way that the pads are located within the calliper. Pad knock results from the pad back plate being forced onto the abutment pins under braking. Pad rattle results from the pad moving between the abutment pins in the off brake condition. Control of the pad to abutment pin air gap, location of the abutment pins and profile of the pad is used to control pad knock. Lift or push type anti-rattle springs are used to control pad rattle.

The above issues are often in conflict with the requirement for the pad to be free enough to slide on the abutment pins in the lengthwise direction of the pins to prevent excessive brake drag torque.

According to the present invention, there is provided a pad retention device for a brake calliper comprising a plurality of pad abutment members adapted to be disposed, in use, at spaced intervals around the periphery of the pad and means for applying a cantilever action to the pad to urge the pad, in use, against one or more of the abutment members.

In a preferred embodiment of the invention, the members are pins. The pins are advantageously elongate and are disposed with their elongate axes extending at right angles or substantially at right angles to the plane in which the pad in use is disposed. There are preferably at least four abutment pins. Two pins are disposed at the trailing edge of the pad, one at the upper edge of the pad closer to the leading edge and one at the leading edge. A further, centre locating, pin at the pad upper edge provides a pivot about which the pad may pivot. The means for applying a cantilever action comprises a cantilever spring. The spring is disposed on the centre locating pin and the upper leading edge abutment pin. In action, it applies a cantilever force against the pad on its upper edge to the trailing side of the centre locating pivot using the upper leading edge abutment pin as a reaction point.

In order that the invention may be more clearly understood one embodiment of the invention will now be described, by way of example, with reference to the accompanying drawings, in which:—

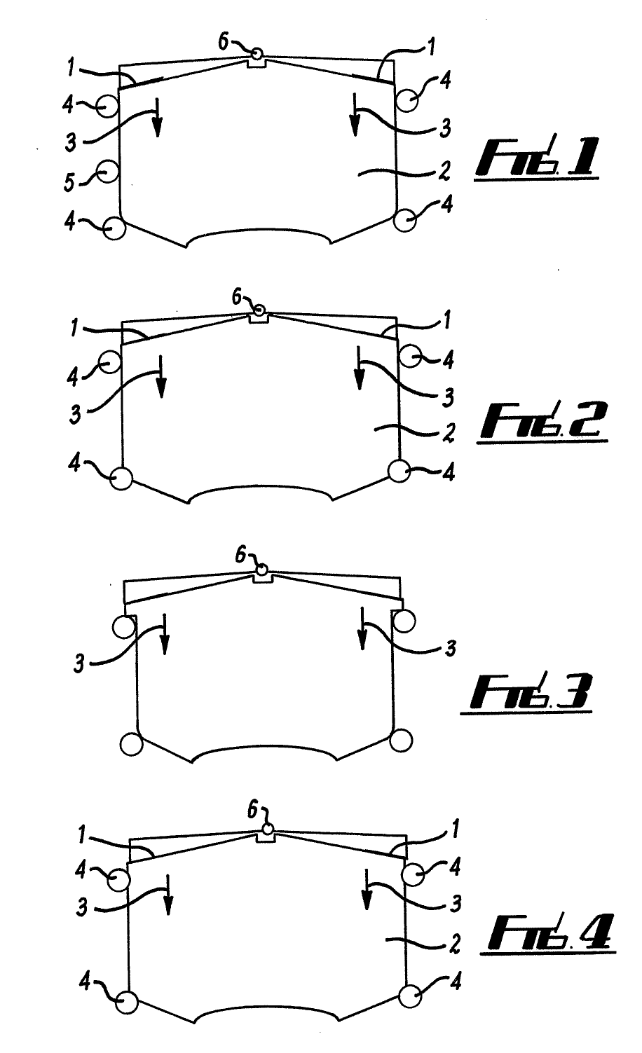

FIGS. 1 to 8 diagrammatically show various known pad retention devices for a brake calliper and

FIGS. 9 and 10 each diagrammatically shows a pad retention device according to the invention.

FIGS. 1 to 8 show various known pad retention devices for a brake calliper for a disc brake for a vehicle. In all cases traditional push springs, referenced 1 in all of the FIGS. 1 to 8, pushes the pad, referenced 2 in all of FIGS. 1 to 8, in a downwardly direction shown in each case by the arrows 3. The springs which are mounted on a centre locating pivot 6 acts in each case on both the leading end and the trailing end of the pad in the same downwards direction. Other known devices use traditional lift springs which act in the same way as the push springs but in an upwardly, rather than a downwardly, direction. In the devices of FIGS. 1, 2, 3, 4, 6, 7 and 8 elongate cylindrical pins extending at right angles to the plane of the pad and its backing plate are disposed at spaced intervals around the periphery of the pad. In the device of FIG. 5 plate abutments extend alongside but slightly spaced away from the pad.

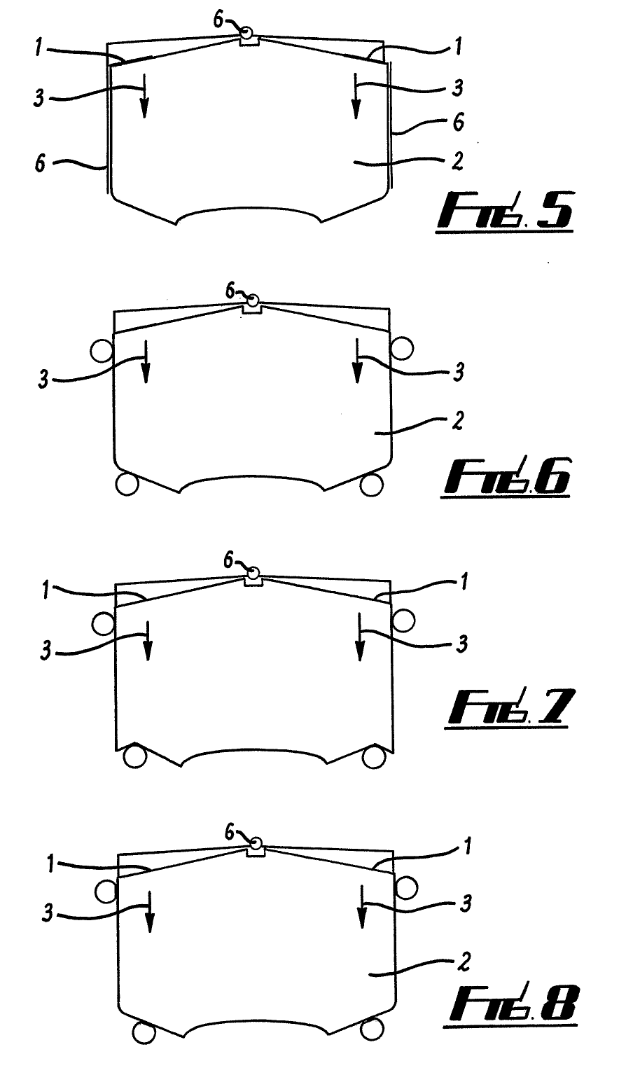

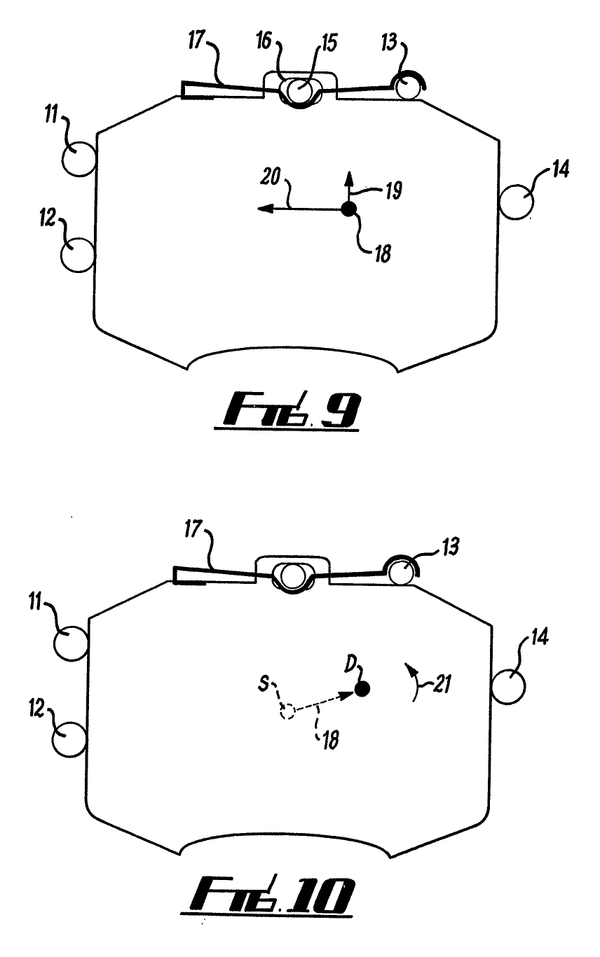

In the device of FIG. 1 an additional abutment pin 5 to the “normal” form abutment pins 4 is provided. In the device of FIG. 2, the abutment pins 4 are staggered as between the top and bottom of the pad 2, and the pad is radiussed to accommodate the lower pins 4. In the device of FIG. 3, the pad is T-shaped to create notches to accommodate the upper pins 4 and in the device of FIG. 4 mismatched radiussed recesses accommodate the pins 4. In the device of FIG. 5 pins are replaced by plate abutments 6. This can produce a particular problem for, if the pad expands as its temperature rises during use, it can jam between the plate abutments. In the devices of FIGS. 6 and 7 the pads are specially shaped to support the abutment pins 4. FIG. 6 shows chamfered abutments and FIG. 7 V-shaped abutments. The device of FIG. 8 shows pins with flat combined with chamfered pads. All of the devices suffer to a greater or lesser degree from the problems mentioned above in the introductory part of the specification.

Referring to FIG. 9, in the arrangement of the invention, the pad retention device comprises four spaced elongate cylindrical abutment pins dispersed at spaced intervals around the periphery of the pad 10. These pins include two trailing edge pins 11 and 12 and two leading edge pins 13 and 14. Pin 13 is disposed adjacent the upper leading edge. A centre locating and retaining pin 15 extends through an aperture 16 in the back plate of the pad. A cantilever spring 17 is mounted on the centre locating and retaining pin 15 and the upper leading edge abutment pin 13. In use, using the pin 13 as a reaction point and the centre locating and retaining pin 15 as a pivot pin, the spring 17 bears down on the pad 10 on the trailing edge side of the pin 15. This in turn tends to rotate the pad in an anticlockwise direction reducing or eliminating pad to abutment pin air gaps and therefore pad rattle and pad knock. In FIG. 8, the pad pressure centre is shown at 18 and radial and tangential forces during forward braking by arrows 19 and 20.

The system provides a lift force on the pad with a push type spring in the form of a cantilever spring. By using a push type spring to perform the function of a lift spring the complexity of the pad profile is reduced. The system controls the dynamic pad radial orientation with a single upper mounted leading edge pin. Controlling the radial pad orientation with an upper mounted pin and using a cantilever spring keeps the number of retaining pins down to one per calliper. Even pad load distribution is controlled on the trailing edge pins by the pad sliding on the upper leading edge abutment pin.

Referring to FIG. 10, the pad retention system provides improved squeal noise resistance within the design. Certain vibration modes of a disc brake, leading to the generation of audible squeal noise, involve radial movement of the pad within the spring retention system, with consequent loss of friction damping between pad and abutment pins. Such radial movement is attributable to the migration of the pad pressure centre 18 from the static pad pressure centre position S to the dynamic pad pressure centre position D (shown in FIG. 10) during forward braking. The pad's pressure centre typically moves tangentially towards the leading edge and radially outward from the static pressure centre. This shift in the dynamic pad pressure centre results in a pad turning moment 21 being generated about the trailing edge upper abutment pin 11. In the case of a conventional calliper pad spring arrangement, the turning moment produces a resultant force that unloads the pad from at least one of the abutment pins, leading to an indeterminate pad position, loss of damping force and a tendency to instability.

In the case of the inventive calliper pad spring arrangement, an installed static moment is already established in the same sense as the moment developed during braking. During braking, therefore, the pad position remains determinate and stable. Friction damping between pad and pins is thus preserved, and brake squeal noise minimized.

It will be appreciated that the above embodiment has been described by way of example only and that many variations are possible within the scope of the invention.

1. A pad retention device for a brake calliper comprising a plurality of pad abutment members adapted to be disposed, in use, at spaced intervals around the periphery of the pad and means for applying a cantilever action to the pad to urge the pad, in use, against one or more of the abutment members.

2. A pad retention device as claimed in claim 1, in which the abutment members comprise pins.

3. A pad retention device as claimed in claim 2, in which the pins are elongate and are disposed with their elongate axes extending at right angles or substantially at right angles to the plane in which the pad in use is disposed.

4. A pad retention device as claimed in claim 1, in which there are at least four abutment members.

5. A pad retention device as claimed in claim 1, in which two pad abutment members are disposed at the trailing edge of the pad in use, one at the upper edge of the pad in use closer to the leading edge and one at the leading edge of the pad in use.

6. A pad retention device as claimed in claim 5, in which the abutment members comprise pins and a further, centre locating, pin is disposed at the upper edge of the pad in use operative to provide a pivot about which the pad may pivot.

7. A pad retention device as claimed in claim 6, in which the means for applying a cantilever action comprises a cantilever spring.

8. A pad retention device as claimed in claim 7, in which the spring is disposed on the centre locating pin and the upper leading edge abutment pin and is operative to apply a cantilever force against the pad on its upper edge to the trailing side of the centre locating pivot using the upper leading edge abutment pin as a reaction point.

9. A pad retention device as claimed in claim 1 wherein each of the abutment members comprises an elongate pin including an elongate axis extending substantially at right angles to the plane in which the pad in use is disposed.

10. A pad retention device as claimed in claim 9 wherein there are at least four abutment members.

11. A pad retention device as claimed in claim 1 wherein each abutment member comprises a pin and the plurality of pins include two trailing edge pins and two leading edge pins.

12. A pad retention device as claimed in claim 11 and further including a center locating and retaining pin that is disposed at the top of the pad and between the trailing edge and leading edge pins.

13. A pad retention device as claimed in claim 12 wherein the means for applying a cantilever action comprises a cantilever spring.

14. A pad retention device as claimed in claim 13 wherein the spring is disposed contacting the center locating and retaining pin, and at one end thereof one of the upper leading edge abutment pins.

15. A pad retention device as claimed in claim 14 wherein the cantilever spring is operative to apply a cantilever force against the pad on its upper edge to the trailing side of the center locating and retaining pin using the upper leading edge abutment pin as a reaction point.

16. A pad retention device for a brake calliper comprising a plurality of pad abutment members adapted to be disposed, in use, at spaced intervals around the periphery of the pad and a cantilever spring for applying a cantilever action to the pad to urge the pad, in use, against one or more of the abutment members.

17. A pad retention device as claimed in claim 16 further including a center locating and retaining pin supported at the top of the pad.

18. A pad retention device as claimed in claim 17 wherein the cantilever spring has a free end engageable with one of the abutment members, said abutment members each include an abutment pin with the cantilever spring applying a cantilever force against the pad on its upper edge.

19. A pad retention device as claimed in claim 18 wherein the center locating and retaining pin extends through an aperture in the back plate of the pad.

20. A pad retention device as claimed in claim 19 wherein there are at least four abutment members.
